(19) United States
(12) Patent Application Publication
(10) Pub. No.: US 2024/0234925 A9
(43) Pub. Date: Jul. 11, 2024

(54) Battery Module

(71) Applicant: Prime Planet Energy & Solutions, Inc., Tokyo (JP)

(72) Inventors: Satoshi KUGINO, Kasai-shi (JP); Kosyo ABE, Himeji-shi (JP); Tomochika TERANAKA, Osaka (JP)

(21) Appl. No.: 18/474,223

(22) Filed: Sep. 26, 2023

(30) Foreign Application Priority Data
Oct. 20, 2022 (JP) 2022-168091

(51) Int. Cl. H01M 50/296; H01M 50/209; H01M 50/262

(52) U.S. Cl. CPC H01M 50/296; H01M 50/209; H01M 50/262

(57) ABSTRACT

A terminal member is electrically connected to at least one battery cell of a plurality of battery cells. A holder is located at an end portion of a stack and can fix the terminal member by inserting the terminal member into the holder in a first direction. One of the terminal member and the holder is provided with a first protrusion protruding in a second direction orthogonal to the first direction. The other of the terminal member and the holder is provided with a first recess fitted to the first protrusion.

### CROSS REFERENCE TO RELATED APPLICATIONS

This nonprovisional application is based on Japanese Patent Application No. 2022-168091 filed on Oct. 20, 2022 with the Japan Patent Office, the entire contents of which are hereby incorporated by reference.

### BACKGROUND OF THE INVENTION

### Field of the Invention

The present technology relates to a battery module.

### Description of the Background Art

Japanese Patent Laying-Open No. 2020-064733 is a prior art document that discloses a configuration of a battery module. In the battery module described in Japanese Patent Laying-Open No. 2020-064733, when connecting an end bus bar to a terminal connected to a wiring for external connection, a fastening portion to which the end bus bar is fastened is inserted into a fitting portion of a plate to fix the end bus bar to the plate.

Japanese Patent Laying-Open No. 2016-018766 is a prior art document that discloses a configuration of a power storage module. The power storage module described in Japanese Patent Laying-Open No. 2016-018766 is provided with a terminal block that electrically connects an electrode terminal of a power storage battery to an output line. The terminal block is fixed to an end plate at a plurality of fixing points.

### SUMMARY OF THE INVENTION

In some cases, a terminal member for connecting an external terminal to a battery cell is fixed to a holder provided in a battery module. When the configuration of the battery module described in Japanese Patent Laying-Open No. 2020-064733 is used to insert the terminal member into the holder and fix the terminal member thereto, the terminal member may be detached in a direction opposite to a direction of insertion, with the result that it is difficult to fix the terminal member to avoid the terminal member from being detached from the holder. Further, in the configuration of the power storage module described in Japanese Patent Laying-Open No. 2016-018766, a configuration for assembling the terminal member to the holder becomes complicated.

The present technology has been made to solve the above-described problem and has an object to provide a battery module in which a terminal member can be fixed to a holder to avoid the terminal member from being detached from the holder, while assembling the terminal member to the holder in a simple manner.

The present technology provides the following battery module.

[1]

A battery module comprising:
a stack in which a plurality of battery cells are arranged side by side;
a terminal member electrically connected to at least one battery cell of the plurality of battery cells; and
a holder located at an end portion of the stack, the holder being able to fix the terminal member by inserting the terminal member into the holder in a first direction, wherein
one of the terminal member and the holder is provided with a first protrusion protruding in a second direction orthogonal to the first direction, and
the other of the terminal member and the holder is provided with a first recess fitted to the first protrusion.

[2]

The battery module according to [1], wherein
the terminal member has a low-rigidity portion, and
the first protrusion and the first recess are fitted to each other with elastic deformation of the low-rigidity portion.

[3]

The battery module according to [1] or [2], wherein the first recess is provided in a vicinity of a tip of the terminal member in a direction of insertion in the first direction.

[4]

The battery module according to any one of [1] to [3], wherein
the holder has a claw portion protruding in the second direction, and
the claw portion is arranged side by side with the terminal member in a third direction orthogonal to the first direction and the second direction, and fixes the terminal member in the third direction.

[5]

The battery module according to any one of [1] to [4], further comprising a bolt member fastened to the terminal member, wherein
the bolt member includes a plate-shaped portion and a screw portion, the screw portion protruding from the plate-shaped portion in a third direction orthogonal to the first direction and the second direction, the screw portion extending through the terminal member along the third direction, the screw portion being fastened to the terminal member,
the plate-shaped portion is inserted into the holder in the first direction so as to be fixed to the holder,
one of the plate-shaped portion and the holder has a second protrusion protruding in the second direction, and
the other of the plate-shaped portion and the holder has a second recess fitted to the second protrusion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a configuration of a battery module according to a first embodiment of the present technology.

FIG. 2 is a perspective view showing an internal configuration of the battery module according to the first embodiment of the present technology.

FIG. 3 is a perspective view showing a configuration of a unit included in the battery module according to the first embodiment of the present technology.

FIG. 4 is a perspective view showing a configuration of a battery cell included in the battery module according to the first embodiment of the present technology.

FIG. 5 is a perspective view showing a configuration around a terminal member included in the battery module according to the first embodiment of the present technology.

FIG. 6 is a front view showing configurations of the terminal member and a holder included in the battery module according to the first embodiment of the present technology.

FIG. 7 is a front view showing a state during assembling of the terminal member to the holder.

FIG. 8 is a front view showing configurations of a bolt member and the holder included in the battery module according to the first embodiment of the present technology.

FIG. 9 is a front view showing configurations of a terminal member and a holder included in a battery module according to a second embodiment of the present technology.

FIG. 10 is a front view showing configurations of a terminal member and a holder included in a battery module according to a third embodiment of the present technology.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium ion battery. In the present specification, the term “electrode” may collectively represent a positive electrode and a negative electrode.

In the present specification, the term “battery cell” is not necessarily limited to a prismatic battery cell and may include a cell having another shape such as a cylindrical battery cell.

Further, the “battery module” can be mounted on vehicles such as a hybrid electric vehicle (HEV), a plug-in hybrid electric vehicle (PHEV), and a battery electric vehicle (BEV). It should be noted that the use of the “battery module” is not limited to the use in a vehicle.

It should be noted that in each of the figures, an X direction serving as a second direction is defined as a direction in which a first protrusion protrudes, a Y direction serving as a third direction is defined as a direction in which a terminal member and a claw portion of a holder are arranged side by side, and a Z direction serving as a first direction is defined as a direction in which the terminal member is inserted into the holder.

### First Embodiment

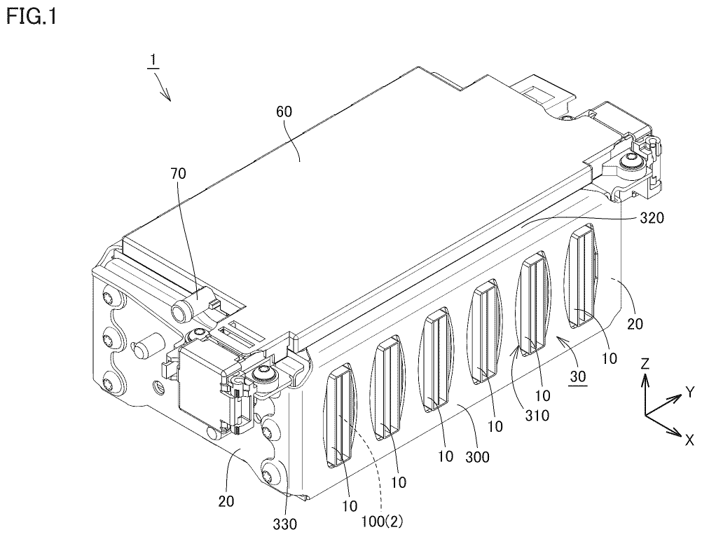

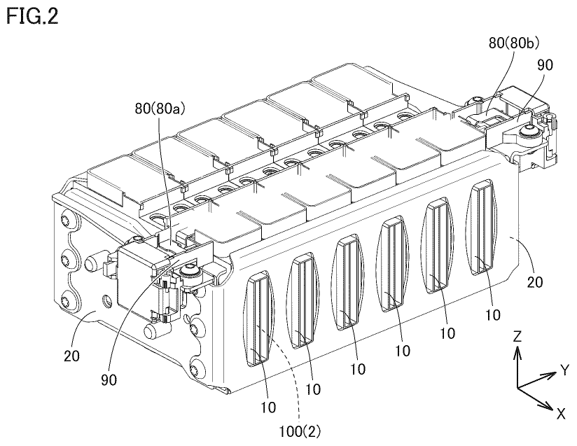

FIG. 1 is a perspective view showing a configuration of a battery module according to a first embodiment of the present technology. FIG. 2 is a perspective view showing an internal configuration of the battery module according to the first embodiment of the present technology.

First, an overall structure of battery module 1 will be described. As shown in FIGS. 1 and 2, battery module 1 includes a plurality of units 10, end plates 20, restraint members 30, a cover member 60, a gas duct 70, terminal members 80, and holders 90.

The plurality of units 10 are arranged side by side in the Y direction. Six units are arranged side by side in the Y direction as the plurality of units 10 according to the present embodiment. It should be noted that the number of the plurality of units is not particularly limited as long as two or more units 10 are included. A plurality of below-described battery cells 100 accommodated in each of the plurality of units 10 are arranged side by side in the Y direction to form a stack 2.

The plurality of units 10 are sandwiched between two end plates 20. The plurality of units 10 according to the present embodiment are pressed by end plates 20 and restrained between two end plates 20.

End plates 20 are provided at the both ends beside the plurality of units 10 in the Y direction. Each of end plates 20 is fixed to a base such as a pack case that accommodates battery module 1. End plate 20 is composed of, for example, aluminum or iron.

Restraint members 30 are provided on both sides beside the plurality of units 10 and end plates 20 in the X direction. When restraint members 30 are engaged with end plates 20 with compressive force in the Y direction being applied to the plurality of units 10 arranged side by side and to end plates 20 and then the compressive force is released, tensile force acts on restraint members 30 that connect two end plates 20. As a reaction thereto, restraint member 30 presses two end plates 20 in directions of bringing them closer to each other. As a result, restraint members 30 restrain the plurality of units 10 in the Y direction.

Each of restraint members 30 includes a main portion 300, a first flange portion 320, and second flange portions 330. Restraint member 30 is composed of iron, for example.

Main portion 300 is a member extending in the Y direction. Main portion 300 is provided with a plurality of openings 310. The plurality of openings 310 are provided at intervals in the Y direction. Each of openings 310 is constituted of a through hole extending through main portion 300 in the X direction.

First flange portion 320 extends from beside the side surfaces of the plurality of units 10 so as to be located over the upper surfaces of the plurality of units 10. By providing first flange portion 320, rigidity of restraint member 30 formed to be relatively thin can be secured.

Second flange portions 330 are connected to both ends of main portion 300 in the Y direction. Second flange portions 330 are fixed to end plates 20. Each of second flange portions 330 is fixed to end plate 20 by a known fixing method such as bolt fastening, for example. Thus, restraint members 30 connect two end plates 20 to each other.

As shown in FIG. 1, cover member 60 protects electric connection of battery module 1. Cover member 60 is located above units 10. Gas duct 70 extends in the Y direction. Gas duct 70 is disposed between each of the plurality of units 10 and cover member 60 in the Z direction.

As shown in FIG. 2, terminal members 80 are disposed on both sides beside the plurality of units 10 each including stack 2 in the Y direction. Each of terminal members 80 is composed of an electric conductor. Terminal members 80 include a positive-side terminal member 80a and a negative-side terminal member 80b. Each of terminal members 80 forms a path for electric connection between battery module 1 and a driving source or the like disposed outside battery module 1.

Holders 90 are located at end portions beside the plurality of units 10 each including stack 2 in the Y direction. Each of holders 90 has an insulating property. Holder 90 is connected to end plate 20 by a known method such as bolt fastening. Terminal member 80 is fixed to holder 90.

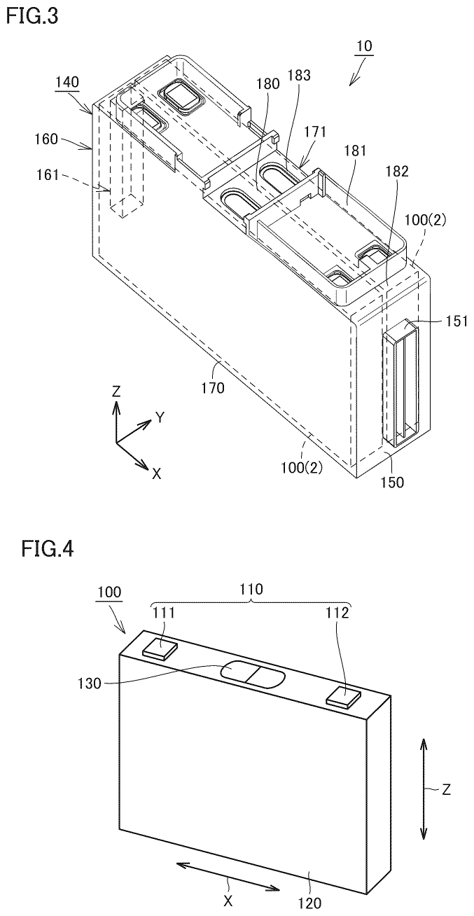

Next, a structure of each unit 10 will be described. FIG. 3 is a perspective view showing a configuration of the unit included in the battery module according to the first embodiment of the present technology.

As shown in FIG. 3, each of the plurality of units 10 includes a plurality of battery cells 100 and a case 140.

Unit 10 includes two or more battery cells 100. Unit 10 according to the present embodiment includes two battery cells 100 as an even number of battery cells 100. It should be noted that the number of battery cells 100 included in each of the plurality of units 10 is not particularly limited as long as two or more battery cells 100 are included. Moreover, an odd number of battery cells 100 may be included in each of the plurality of units 10.

Two battery cells 100 are arranged side by side in the Y direction as the plurality of battery cells 100. The arrangement direction of the plurality of units 10 is the same as the arrangement direction of the plurality of battery cells 100 in each of the plurality of units 10. The plurality of battery cells 100 are electrically connected together by a bus bar (not shown).

Case 140 has an external appearance with a rectangular parallelepiped shape. Case 140 accommodates the plurality of battery cells 100 and supports the plurality of battery cells 100 at least in the Y direction. Case 140 is composed of, for example, a resin such as polypropylene. As shown in FIGS. 1 and 2, case 140 is compressed in the Y direction by restraint members 30.

As shown in FIG. 3, case 140 has a front wall portion 150, a rear wall portion 160, a first side wall portion 170, a second side wall portion 171, and an upper surface portion 180.

Front wall portion 150 is a surface adjacent to one restraint member 30. Front wall portion 150 is provided with a first duct portion 151. First duct portion 151 protrudes from front wall portion 150 toward the one restraint member 30 side. First duct portion 151 is provided to extend through front wall portion 150 in the X direction.

Rear wall portion 160 is a surface facing front wall portion 150 with the plurality of battery cells 100 being interposed therebetween in the X direction. Rear wall portion 160 is provided with a second duct portion 161. Second duct portion 161 protrudes from rear wall portion 160 toward the other restraint member 30 side. Second duct portion 161 is provided to extend through rear wall portion 160 in the X direction. Second duct portion 161 communicates with first duct portion 151 through a cooling medium path (not shown) provided in case 140.

First side wall portion 170 and second side wall portion 171 are arranged side by side in the Y direction, and face each other.

Upper surface portion 180 includes a plurality of wall portions 181, engagement surfaces 182, and a plurality of hole portions 183. The plurality of wall portions 181 are provided to extend upward in the Z direction. The plurality of wall portions 181 define an installation location of the bus bar (not shown). First flange portion 320 of restraint member 30 is engaged with each engagement surface 182. The plurality of hole portions 183 are formed such that electrode terminals 110 and a gas-discharge valve 130, which will be described later, are exposed from upper surface portion 180.

FIG. 4 is a perspective view showing a configuration of each battery cell included in the battery module according to the first embodiment of the present technology.

As shown in FIG. 4, battery cell 100 is, for example, a lithium ion battery.

Battery cell 100 has a prismatic shape. Battery cell 100 has an output density of, for example, about 8000 W/L or more. Battery cell 100 has a voltage of, for example, about 1.0 V or more.

Battery cell 100 according to the present embodiment has electrode terminals 110, a housing 120, and gas-discharge valve 130.

Electrode terminals 110 are formed on housing 120. Electrode terminals 110 have a positive electrode terminal 111 and a negative electrode terminal 112 as two electrode terminals 110 arranged side by side along the X direction.

Positive electrode terminal 111 and negative electrode terminal 112 are provided to be separated from each other in the X direction. Positive electrode terminal 111 and negative electrode terminal 112 are provided on both sides beside gas duct 70 in the X direction. Positive electrode terminal 111 and negative electrode terminal 112 are joined to the bus bar by laser welding or the like.

Housing 120 has a rectangular parallelepiped shape, and forms the external appearance of battery cell 100. An electrode assembly (not shown) and an electrolyte solution (not shown) are accommodated in housing 120.

Gas-discharge valve 130 is provided in the upper surface portion of housing 120. When internal pressure of housing 120 becomes more than or equal to a predetermined value due to gas generated inside housing 120, gas-discharge valve 130 discharges the gas to the outside of housing 120. The gas from gas-discharge valve 130 flows through gas duct 70 and is discharged to the outside of battery module 1.

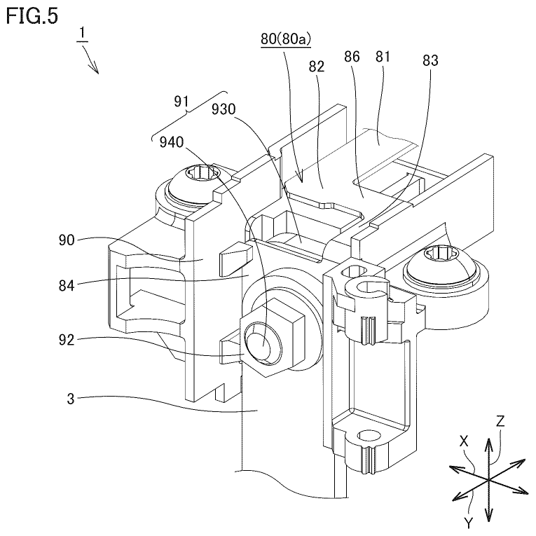

FIG. 5 is a perspective view showing a configuration around the terminal member included in the battery module according to the first embodiment of the present technology. It should be noted that positive-side terminal member 80a will be described in the following explanation for terminal member 80; however, the same structure as that of positive-side terminal member 80a can be applied to negative-side terminal member 80b except that positive-side terminal member 80a has a fuse portion 86 described later.

As shown in FIG. 5, terminal member 80 according to the present embodiment includes a first path 81, a second path 82, a third path 83, and a main body portion 84.

First path 81 is located above a battery cell 100. First path 81 is electrically connected to electrode terminal 110 of at least one battery cell 100 of the plurality of battery cells 100. In the present embodiment, terminal member 80 is electrically connected to one battery cell 100 located at an end portion in the Y direction. It should be noted that terminal member 80 may be connected to a plurality of battery cells 100 by one joining portion.

Second path 82 is connected to first path 81 and extends in the X direction. Second path 82 includes fuse portion 86.

Fuse portion 86 is located at substantially the center of second path 82 in the X direction. Fuse portion 86 has a narrower width than those of other portions of second path 82 than fuse portion 86. When an excessive amount of current flows to terminal member 80 due to a short circuit or the like, fuse portion 86 is melted first, thereby disconnecting second path 82. As a result, the excessive amount of current is prevented from flowing into battery module 1

Third path 83 is connected to second path 82 and extends in the Y direction. The width of third path 83 is desirably the same as the width of first path 81.

Main body portion 84 is connected to third path 83 and extends in an XZ plane. Main body portion 84 is fastened by a below-described bolt member 91, and is electrically connected to an external terminal 3.

Battery module 1 according to the present embodiment further includes bolt member 91 and a nut member 92.

Bolt member 91 includes a plate-shaped portion 930 and a screw portion 940. Bolt member 91 is composed of a metal material such as steel, for example.

Plate-shaped portion 930 extends in the XZ plane. Plate-shaped portion 930 is in abutment with holder 90 in the Y direction. Screw portion 940 protrudes from plate-shaped portion 930 in a third direction (Y direction) orthogonal to the first direction (Z direction) and the second direction (X direction). Screw portion 940 extends through terminal member 80 along the third direction (Y direction). In the present embodiment, a through hole 840 described later is provided in main body portion 84 of terminal member 80, and screw portion 940 extends through through hole 840 in the Y direction.

Nut member 92 is screwed into screw portion 940 with main body portion 84 and external terminal 3 being interposed between nut member 92 and plate-shaped portion 930. Nut member 92 is composed of a metal material such as steel, for example. By screwing nut member 92 into screw portion 940, bolt member 91 is fastened to terminal member 80 together with external terminal 3. Thus, terminal member 80 and external terminal 3 are electrically connected to each other.

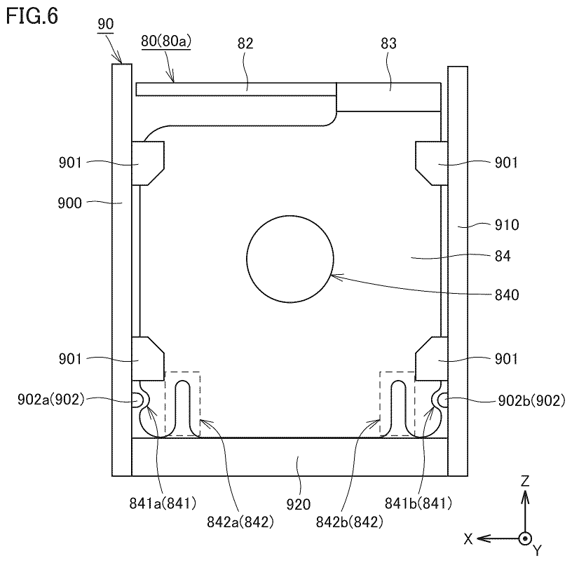

FIG. 6 is a front view showing configurations of the terminal member and the holder included in the battery module according to the first embodiment of the present technology.

As shown in FIG. 6, holder 90 can fix terminal member 80 by inserting terminal member 80 into holder 90 in the first direction (Z direction). Holder 90 according to the present embodiment fixes main body portion 84 by inserting main body portion 84 of terminal member 80 thereinto in the first direction (Z direction).

Holder 90 has a first side surface portion 900, a second side surface portion 910, a bottom surface portion 920, claw portions 901, and first protrusions 902.

First side surface portion 900 and second side surface portion 910 each extend in the Z direction and face each other in the X direction. First side surface portion 900 and second side surface portion 910 are located with terminal member 80 being interposed therebetween. Bottom surface portion 920 extends in the X direction and is located at an end portion of each of first side surface portion 900 and second side surface portion 910 in the Z direction. Bottom surface portion 920 supports main body portion 84.

The pair of first protrusions 902 are provided on both sides of holder 90 in the X direction. Specifically, as first protrusions 902, one first protrusion 902a is provided on first side surface portion 900, and the other first protrusion 902b is provided on second side surface portion 910. One first protrusion 902a and the other first protrusion 902b are provided at substantially the same height in the first direction (Z direction).

Each of first protrusions 902 protrudes in the second direction (X direction) orthogonal to the first direction (Z direction). In the present embodiment, each of one first protrusion 902a and the other first protrusion 902b protrudes toward main body portion 84 in the second direction (X direction).

Each of claw portions 901 protrudes in the second direction (X direction). Specifically, the plurality of claw portions 901 are provided and protrude from first side surface portion 900 and second side surface portion 910 in the second direction (X direction). Four claw portions 901 are provided at intervals so as to uniformly fix main body portion 84.

Claw portions 901 are arranged side by side with main body portion 84 of terminal member 80 in the third direction (Y direction). Thus, claw portions 901 fix terminal member 80 in the third direction (Y direction).

It should be noted that the number of claw portions 901 is not limited to four, and may be at least one or more. Further, the direction in which each of claw portions 901 protrudes is not limited to the X direction, and each of the claw portions may be provided on bottom surface portion 920 to protrude in the Z direction.

Main body portion 84 of terminal member 80 is provided with first recesses 841 and first low-rigidity portions 842.

The pair of first recesses 841 are provided in the both sides of main body portion 84 in the X direction. Specifically, as first recesses 841, one first recess 841a is provided to face first side surface portion 900, and the other first recess 841b is provided to face second side surface portion 910.

One first recess 841a and the other first recess 841b are provided at substantially the same height in the first direction (Z direction). Each of first recesses 841 is provided in the vicinity of the tip of terminal member 80 in the direction of insertion in the first direction (Z direction). The vicinity of the tip in the present embodiment is a position at a height above the tip of main body portion 84 (lower end of main body portion 84 in FIG. 6) by about 1/20 or more and ⅕ or less of the height of main body portion 84 in the Z direction.

First recesses 841 are fitted to first protrusions 902 in the second direction (X direction) with respect to the direction of insertion in the first direction (Z direction). Thus, terminal member 80 is fixed to holder 90 in the first direction (Z direction). Further, in the present embodiment, since main body portion 84 is adjacent to and interposed between first side surface portion 900 and second side surface portion 910, first recesses 841 are fixed to holder 90 in the second direction (X direction). Further, main body portion 84 is fixed thereto in the third direction (Y direction) by claw portions 901.

As described above, terminal member 80 is fixed to holder 90 in each of the first direction (Z direction), the second direction (X direction), and the third direction (Y direction). It should be noted that there may be a clearance between first protrusion 902 and first recess 841 in the X direction, or there may be no clearance therebetween with first protrusion 902 and first recess 841 being elastically deformed.

The pair of first low-rigidity portions 842 are provided on the inner side with respect to respective first recesses 841 in the X direction. Specifically, as first low-rigidity portions 842, one first low-rigidity portion 842a is provided adjacent to one first recess 841a, and the other first low-rigidity portion 842b is provided adjacent to the other first recess 841b.

Each of first low-rigidity portions 842 is a portion of terminal member 80 having a low rigidity. That is, first low-rigidity portion 842 is a portion that is likely to be deformed among the configurations of terminal member 80. In the present embodiment, first low-rigidity portion 842 has a low rigidity because a groove is formed therein. It should be noted that first low-rigidity portion 842 may be formed by partially reducing the thickness of main body portion 84, or first low-rigidity portion 842 may be composed of a material that is more likely to be deformed than the other configurations of terminal member 80.

First protrusion 902 and first recess 841 are fitted to each other with elastic deformation of first low-rigidity portion 842. By the elastic deformation of first low-rigidity portion 842, the position of adjacent first recess 841 can be readily displaced, with the result that first protrusion 902 and first recess 841 can be readily fitted to each other.

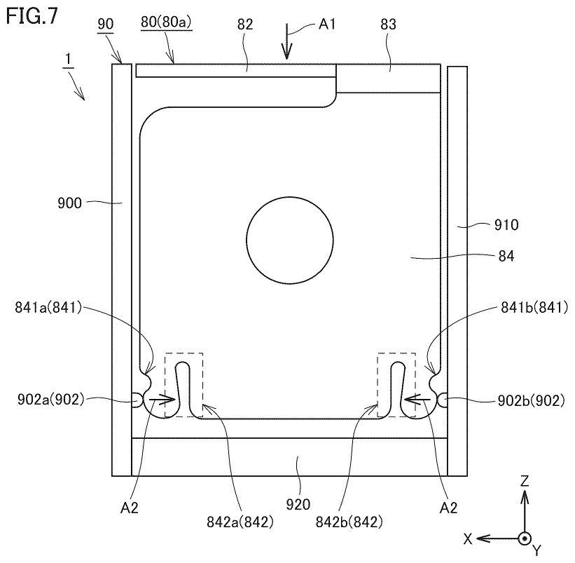

FIG. 7 is a front view showing a state during assembling of the terminal member to the holder. It should be noted that in FIG. 7, claw portions 901 are not shown to facilitate understanding of the invention.

As shown in FIG. 7, terminal member 80 is inserted into holder 90 in the direction of insertion (A1 direction). When terminal member 80 is inserted into holder 90, the tip of main body portion 84 in the direction of insertion (A1 direction) is brought into contact with first protrusions 902. On this occasion, the tip of main body portion 84 in the direction of insertion (A1 direction) is pressed from first protrusions 902 to elastically deform first low-rigidity portions 842. First low-rigidity portion 842 of the present embodiment is elastically deformed to narrow the width of the groove portion. Thus, the tip of main body portion 84 in the direction of insertion (direction A1) is moved in directions of arrows A2.

When terminal member 80 is inserted until it is brought into abutment with bottom surface portion 920, the tip of main body portion 84 in the direction of insertion (direction A1) is returned to the same position in the X direction as that before the insertion. Thus, first recesses 841 of terminal member 80 are fitted to first protrusions 902 of holder 90.

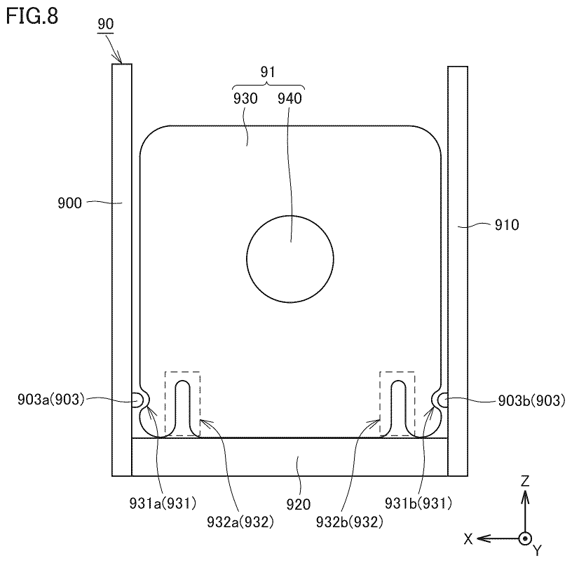

FIG. 8 is a front view showing configurations of the bolt member and the holder included in the battery module according to the first embodiment of the present technology.

As shown in FIG. 8, plate-shaped portion 930 of bolt member 91 is inserted into holder 90 in the first direction (Z direction) so as to be fixed thereto.

Holder 90 further has second protrusions 903. The pair of second protrusions 903 are provided on the both sides of holder 90 in the X direction. Specifically, as second protrusions 903, one second protrusion 903a is provided on first side surface portion 900, and the other second protrusion 903b is provided on second side surface portion 910. One second protrusion 903a and the other second protrusion 903b are provided at substantially the same height in the first direction (Z direction).

Each of second protrusions 903 protrudes in the second direction (X direction). In the present embodiment, one second protrusion 903a and the other second protrusion 903b protrude toward plate-shaped portion 930 in the second direction (X direction).

Plate-shaped portion 930 is provided with second recesses 931 and second low-rigidity portions 932.

The pair of second recesses 931 are provided in the both sides of plate-shaped portion 930 in the X direction. Specifically, as second recesses 931, one second recess 931a is provided to face first side surface portion 900, and the other second recess 931b is provided to face second side surface portion 910.

One second recess 931a and the other second recess 91b are provided at substantially the same height in the first direction (Z direction). Each of second recesses 931 in the present embodiment is provided in the vicinity of the tip of bolt member 91 in the direction of insertion in the first direction (Z direction). The vicinity of the tip in the present embodiment is a position at a height above the tip of plate-shaped portion 930 (lower end of plate-shaped portion 930 in FIG. 8) by about 1/20 or more and ⅕ or less of the height of plate-shaped portion 930 in the Z direction.

Second recesses 931 are fitted to second protrusions 903 in the second direction (X direction) with respect to the direction of insertion in the first direction (Z direction). Thus, bolt member 91 is fixed to holder 90 in the first direction (Z direction). Further, in the present embodiment, since plate-shaped portion 930 is adjacent to and interposed between first side surface portion 900 and second side surface portion 910, second recesses 931 are fixed to holder 90 in the second direction (X direction). Thus, bolt member 91 is fixed to holder 90 in the first direction (Z direction) and the second direction (X direction). It should be noted that there may be a clearance between second protrusion 903 and second recess 931 in the X direction, or there may be no clearance therebetween with second protrusion 903 and second recess 931 being elastically deformed.

The pair of second low-rigidity portions 932 are provided on the inner side with respect to respective second recesses 931 in the X direction. Specifically, as second low-rigidity portions 932, one second low-rigidity portion 932a is provided adjacent to one second recess 931a, and the other second low-rigidity portion 932b is provided adjacent to the other second recess 91b.

Each of second low-rigidity portions 932 is a portion of plate-shaped portion 930 having a low rigidity. That is, second low-rigidity portion 932 is a portion that is likely to be deformed among the configurations of plate-shaped portion 930. In the present embodiment, the rigidity thereof is low because a groove is formed therein.

Second protrusion 903 and second recess 931 are fitted to each other with elastic deformation of second low-rigidity portion 932. By the elastic deformation of second low-rigidity portion 932, the position of adjacent second recess 931 can be readily displaced, with the result that second protrusion 903 and second recess 931 can be readily fitted to each other.

When bolt member 91 is inserted into holder 90 in the Z direction, the tip of plate-shaped portion 930 in the direction of insertion is brought into contact with second protrusion 903 to elastically deform second low-rigidity portion 932. Thus, the tip of plate-shaped portion 930 in the direction of insertion is moved to narrow the width thereof in the X direction.

Thereafter, when bolt member 91 is inserted until it is brought into abutment with bottom surface portion 920, the tip of plate-shaped portion 930 in the direction of insertion (direction A1) is returned to the same position in the X direction as that before the insertion. Thus, second recesses 931 of bolt member 91 are fixed to second protrusions 903 of holder 90.

In battery module 1 according to the first embodiment of the present technology, since first protrusion 902 provided on holder 90 is fitted to first recess 841 provided in terminal member 80 in the direction (X direction) orthogonal to the direction of insertion of terminal member 80, terminal member 80 can be fixed to holder 90 so as to avoid terminal member 80 from being detached from holder 90 while assembling terminal member 80 to holder 90 in a simple manner.

In battery module 1 according to the first embodiment of the present technology, since first low-rigidity portion 842 is provided, elastic deformation is facilitated around first recess 841, with the result that first recess 841 of terminal member 80 and first protrusion 902 of holder 90 can be readily fitted to each other.

In battery module 1 according to the first embodiment of the present technology, since first recess 841 is provided in terminal member 80, terminal member 80 can be fitted to holder 90 in the vicinity of the tip of terminal member 80 in the direction of insertion (A1 direction), with the result that terminal member 80 can be readily fixed to holder 90.

In battery module 1 according to the first embodiment of the present technology, since claw portion 901 is provided on holder 90 to fix terminal member 80, terminal member 80 can be prevented from rising in the third direction (Y direction) with respect to holder 90.

In battery module 1 according to the first embodiment of the present technology, since terminal member 80 is fixed to holder 90 by first protrusion 902 and first recess 841 and bolt member 91 is fixed to holder 90 by second protrusion 903 and second recess 931, both terminal member 80 and bolt member 91 connected to each other are fixed to holder 90, with the result that it is possible to securely fix each configuration around the external terminal.

It should be noted that first protrusions 902 may be constituted of one member and second protrusions 903 may be constituted of one member. When first protrusions 902 are constituted of one member and second protrusions 903 are constituted of one member, first protrusion 902 and second protrusion 903 are desirably arranged side by side in the third direction (Y direction).

Hereinafter, battery modules according to second and third embodiments of the present technology will be described. Since each of the battery modules according to the second and third embodiments of the present technology is different from battery module 1 according to the first embodiment of the present technology in terms of the configurations of the terminal member and the holder, the same configurations as those of battery module 1 according to the first embodiment of the present technology will not be described repeatedly.

### Second Embodiment

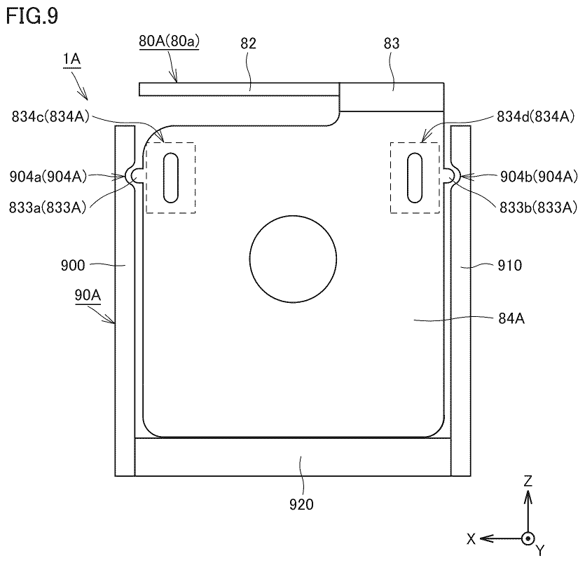

FIG. 9 is a front view showing configurations of a terminal member and a holder included in the battery module according to the second embodiment of the present technology.

As shown in FIG. 9, a terminal member 80A according to the present embodiment has first protrusions 833A and first low-rigidity portions 834A.

The pair of first protrusions 833A are provided on both sides of a main body portion 84A in the X direction. Specifically, as first protrusions 833A, one first protrusion 833a is provided to face first side surface portion 900, and the other first protrusion 833b is provided to face second side surface portion 910.

One first protrusion 833a and the other first protrusion 833b are provided at substantially the same height in the first direction (Z direction). Each of first protrusions 833A in the present embodiment is disposed in the vicinity of an end portion of terminal member 80A opposite to the tip thereof in the direction of insertion in the first direction (Z direction). The vicinity of the end portion opposite to the tip in the present embodiment is a position at a height below the end portion of main body portion 84A (upper end of main body portion 84A in FIG. 9) by about 1/20 or more and ⅕ or less of the height of main body portion 84A in the Z direction.

The pair of first low-rigidity portions 834A are provided on the inner side with respect to first protrusions 833A in the X direction. Specifically, as first low-rigidity portions 834A, one first low-rigidity portion 834c is provided adjacent to one first protrusion 833a, and the other first low-rigidity portion 834d is provided adjacent to the other first protrusion 833b.

A holder 90A is provided with first recesses 904A. The pair of first recesses 904A are provided in both sides of holder 90A in the X direction. Specifically, as first recesses 904A, one first recess 904a is provided in first side surface portion 900, and the other first recess 904b is provided in second side surface portion 910. One first recess 904a and the other first recess 904b are provided at substantially the same height in the first direction (Z direction).

First recesses 904A are fitted to first protrusions 833A. Specifically, first recesses 904A are fitted to first protrusions 833A in the second direction (X direction) with respect to the direction of insertion in the first direction (Z direction). Thus, terminal member 80A is fixed to holder 90A in the first direction (Z direction).

In battery module 1A according to the second embodiment of the present technology, since first protrusion 833A provided on terminal member 80A is fitted to first recess 904A provided in holder 90A in the direction (X direction) orthogonal to the direction of insertion of terminal member 80A, terminal member 80A can be fixed to holder 90A so as to avoid terminal member 80A from being detached from holder 90A while assembling terminal member 80A to holder 90A in a simple manner.

### Third Embodiment

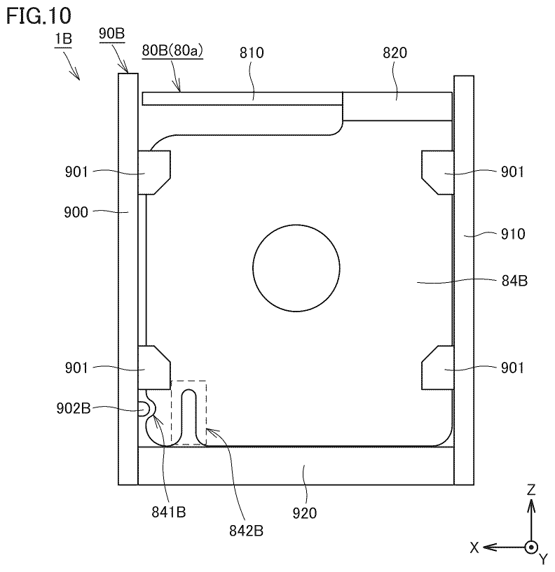

FIG. 10 is a front view showing configurations of a terminal member and a holder included in the battery module according to the third embodiment of the present technology.

As shown in FIG. 10, a terminal member 80B according to the present embodiment is provided with one first recess 841B. A holder 90B is provided with one first protrusion 902B. A side surface of terminal member 80B opposite to the side on which first recess 841B is provided is in abutment with holder 90B. A first low-rigidity portion 842B is provided on the central side of main body portion 84B in the X direction with respect to first recess 841B.

In battery module 1B according to the third embodiment of the present technology, since first protrusion 902B provided on holder 90B is fitted to first recess 841B provided in terminal member 80B in the direction (X direction) orthogonal to the direction of insertion of terminal member 80B, terminal member 80B can be fixed to holder 90B so as to avoid terminal member 80B from being detached from holder 90B while assembling terminal member 80B to holder 90B in a simple manner.

In battery module 1B according to the third embodiment of the present technology, by providing first protrusion 902B only on one of the side surfaces of terminal member 80B located on both sides with respect to the direction of insertion, terminal member 80B can be fixed to holder 90B while positioning terminal member 80B with the other side surface of terminal member 80B being in abutment with holder 90B.

It has been illustratively described that the direction of insertion of the terminal member into the holder is the Z direction; however, it is not limited to this configuration. The direction of insertion of the terminal member into the holder may be the X direction or the Y direction. When the direction of insertion is the X direction or the Y direction, the protruding direction of the protrusion is a direction orthogonal to the direction of insertion.

Further, in each of the above-described embodiments, a whole of each protrusion protrudes in the second direction (X direction); however, it is not limited to this configuration. A part of the protrusion may protrude in the second direction (X direction). For example, the protrusion may be configured such that a root portion of the protrusion extends from the bottom surface portion of the holder in the first direction (Z direction) and a tip portion thereof protrudes in the second direction (X direction). In this case, the recess is provided at the tip of the main body portion of the terminal member in the direction of insertion.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A battery module comprising:
a stack in which a plurality of battery cells are arranged side by side;
a terminal member electrically connected to at least one battery cell of the plurality of battery cells; and
a holder located at an end portion of the stack, the holder being able to fix the terminal member by inserting the terminal member into the holder in a first direction, wherein
one of the terminal member and the holder is provided with a first protrusion protruding in a second direction orthogonal to the first direction, and
the other of the terminal member and the holder is provided with a first recess fitted to the first protrusion.

2. The battery module according to claim 1, wherein
the terminal member has a low-rigidity portion, and
the first protrusion and the first recess are fitted to each other with elastic deformation of the low-rigidity portion.

3. The battery module according to claim 1, wherein the first recess is provided in a vicinity of a tip of the terminal member in a direction of insertion in the first direction.

4. The battery module according to claim 2, wherein the first recess is provided in a vicinity of a tip of the terminal member in a direction of insertion in the first direction.

5. The battery module according to claim 1, wherein
the holder has a claw portion protruding in the second direction, and
the claw portion is arranged side by side with the terminal member in a third direction orthogonal to the first direction and the second direction, and fixes the terminal member in the third direction.

6. The battery module according to claim 2, wherein
the holder has a claw portion protruding in the second direction, and
the claw portion is arranged side by side with the terminal member in a third direction orthogonal to the first direction and the second direction, and fixes the terminal member in the third direction.

7. The battery module according to claim 1, further comprising a bolt member fastened to the terminal member, wherein
the bolt member includes a plate-shaped portion and a screw portion, the screw portion protruding from the plate-shaped portion in a third direction orthogonal to the first direction and the second direction, the screw portion extending through the terminal member along the third direction, the screw portion being fastened to the terminal member,
the plate-shaped portion is inserted into the holder in the first direction so as to be fixed to the holder,
one of the plate-shaped portion and the holder has a second protrusion protruding in the second direction, and
the other of the plate-shaped portion and the holder has a second recess fitted to the second protrusion.

8. The battery module according to claim 2, further comprising a bolt member fastened to the terminal member, wherein
the bolt member includes a plate-shaped portion and a screw portion, the screw portion protruding from the plate-shaped portion in a third direction orthogonal to the first direction and the second direction, the screw portion extending through the terminal member along the third direction, the screw portion being fastened to the terminal member,
the plate-shaped portion is inserted into the holder in the first direction so as to be fixed to the holder,
one of the plate-shaped portion and the holder has a second protrusion protruding in the second direction, and
the other of the plate-shaped portion and the holder has a second recess fitted to the second protrusion.
